(19) United States
(12) Patent Application Publication
(10) Pub. No.: US 2010/0275158 A1
(43) Pub. Date: Oct. 28, 2010

(54) SYSTEM AND A METHOD FOR PROVIDING EVENTS TO A USER

(75) Inventor: John Hammer Madsen, Holstebro (DK)

Correspondence Address: HARNESS, DICKEY & PIERCE, P.L.C., P.O. BOX 8910, RESTON, VA, 20195, US

(73) Assignee: Bang & Olufsen A/S, Struer (DK)

(21) Appl. No.: 12/451,698

(22) PCT Filed: May 22, 2008
(86) PCT No.: PCT/EP2008/056315

§ 371 Date: Nov. 25, 2009

Related U.S. Application Data
(60) Provisional application No. 60/924,680, filed on May 25, 2007.

(51) Int. Cl. G06F 3/048

(52) U.S. Cl. 715/810

(57) ABSTRACT

A system and method for providing events to a user, where, when providing events from a first playlist, the user may instruct the system to generate a second playlist of events related to the event presently provided, and where, when the second playlist has been provided, the system returns to the first playlist.

The present invention relates to the providing of events to a user and in particular the interruption of a play list while playing or providing an event and the providing of another play list with events related to or similar to the provided event, and the subsequent reverting to the original play list.

In a first aspect, the present invention relates to a method of providing events to a user, the method comprising:
providing, such as from a group of events, an initial list of events, each event being characterizable by one or more parameters,
during providing of a first event from the initial list, receiving an input from the user,
generating a second list of events, such as from the group of events, the events of the second list having one or more parameter(s) identical to or similar to one or more parameters of the first event,
providing events of the second list to the user, and
subsequent to providing all events of the second list or to a second input from the user, providing remaining events of the initial list.

In the present context, events may be available from a number of sources, such as from a near-by or internal storage, a remote storage, via a network of any type, or by being streamed from an external source, such as via the WWW or via airborne signals, such as TV or radio signals. Naturally, the storage may be a memory card, RAM, ROM, PROM, EPROM, EEPROM, hard disc or the like or may be one or more CD-ROM/DVD discs the contents of which is made available. The above group of events may be a group of readily available events, such as events available from a nearby storage.

In this context, an event may be any type of event which a user may experience, such as visual or audio information, which may be music, video, text, images, or the like.

Parameters may be provided with the event from external sources, such as the adding of artist or composer by a distributor or producer, or may be derivable there from, such as by analysis of the event (beats-per-minute, genre, duration, etc.). In addition or alternatively, the user may him/herself provide parameters to the events.

In the present context, a parameter may be any piece of information describing the event or something connected thereto. Different standards exist for different types of events, such as the ID3.v2 standard for audio files and EXIF for video. Such parameters may be: author, artist, group, name, title, producer, date/year of production/issuance/birth, genre, theme, pace/beats-per-minute, played recently/never, most/never/recently used, oldies, or the like. In addition, a parameter may be a type of file in which the event is stored (tiff, mpeg, mp3, etc.).

Identical parameters are either the exact same parameters, or one parameter may be contained within the other. An example thereof is the fact that the artist

Michael Jackson was a part of the artist group Jackson Five, whereby these parameters may be seen as identical. It may, however, be desired to use a more strict view on identity and similarity and merely see these parameters as being similar in that additional artists are present in Jackson Five (as would also be the case on e.g. the live aid songs). In that situation, identity between parameters would only exist between tracks having only Michael Jackson as the artist.

Similarity between parameters may be defined in any desired manner. If the parameter is a number, an interval or percentage may be defined within which parameters may be taken to be similar. Similarity between persons may be similarity in gender, age, place/country of birth, citizenship, religion, skin colour, education, taste, sexuality, or the like.

As to the instruments used, the same type of identity and similarity described above for artists may be used.

A particularly suitable manner of estimating or determining identity or similarity is one wherein one or more parameters are predetermined and in which a space is defined having a number of dimensions corresponding to the number of parameters. Then, identity or similarity is estimated on the basis of a distance or angle between points or vectors defined in the space by the parameter(s) of the individual events. The closer or the lower the angle, the more similar the events.

In this respect, it is noted that it could be preferable to allow the user to select different types of similarity, such as by providing one of a number of predetermined or predefined selections of parameters on the basis of which the similarity is estimated. Thus, the user may either determine on the basis of which parameter(s) the similarity determination is to be performed or select one or a number of predetermined parameters or groups of parameters. One group of parameters may relate to the artist and label. Another group of parameters may relate to beats per minute and key. Other parameter groups may relate to year or decade of production and beats per minute or group. Infinite possibilities exist for the user to customize this determination or for customizing predefined groups of parameters which are subsequently selected by the actual input made.

In the present context, the event provider may be any type of media player, such as a stand-alone media player, such as a standard MP3-player, or it may form part of equipment also having other functions, such as a cell phone, a PDA, an eBook, a PC, an AV system or the like.

The input may be tactile, such as detectable via buttons, a touch screen, a joystick, a rotatable wheel or the like, or be adapted to be received and interpreted as audio commands. Alternatively or in addition, the user may input information by moving the player in relation to him/herself or the surroundings, when movement detection means are provided.

A list of events may be a group of links or ID's pointing to the events or may be the actual information stored in a designated storage. A list may have any number of events, such as one or more events. The number of events may be predetermined or not.

In the present context, when the events of the second list have been provided or the user has provided instructions to skip remaining events of the second list, the providing will revert to providing remaining (not provided during the step of providing events from the initial list) events from the initial list. If no other instructions are given, all remaining events of the initial list may be provided.

In one embodiment, the steps of providing the lists of events comprises identifying available events stored in/on available storage means and/or the events available from one or more remote computers. Remote or streaming sources may be the WWW, net radio or standard, airborne radio/TV signals. In addition, the system may be set up to identify events for sale on the WWW and actually perform the purchase and download thereof.

In another embodiment, as mentioned above, the step of generating the second list comprises generating the second list from events having the one or more identical/similar parameters in the group of: author, artist (e.g. Justin Timberlake), group (e.g. the Jackson Five), composer (e.g. Andrew Lloyd Webber), label (e.g. EMI, mute record, motor music, . . . ), genre (e.g. pop, rock, beat, classic, jazz, . . . ), beats-per-minute, key, instruments used, rhythm, spectral contents, name (of any person related to the music), title (such as of the track or album), producer (e.g. Quincy Jones), date/year of production/issuance/birth (of the track, album, artist, composer or any other person related to the music), theme (such as musical, film track), actor(s) (such as Tom Hanks), genre (family, action, thriller . . . ), director (such as George Lucas), and publisher.

It may be preferred that the step of generating the second list comprises performing a real time analysis of the first event in order to determine the one or more parameters. In this connection, the real time analysis is preferably an analysis performed after the user has provided the input and while the actual event is being provided so that this analysis and the providing of the second list preferably is finalized (or at least an event of the second list identified) when—or before—the actual event is finished. In this connection, the events in which the search for events for the second list is performed preferably have been pre-analyzed so that the search may be performed swiftly. Naturally, if the parameter(s) of the provided event are already known from a previous analysis, no real-time analysis thereof is required.

In yet another embodiment, the method further comprises the steps of:
during providing of a second event from the second list, receiving another input from the user,
generating a third list of events, such as from the group of events, the events of the third list having one or more parameter(s) identical to or similar to one or more parameters of the second event,
providing events of the third list to the user, and
subsequent to providing all events of the third list or to a second input from the user, providing remaining events of the second list subsequent.

Thus, the user may introduce instructions to again revert from the actual list and generate and provide yet another list of events which, again, have parameters similar to or identical to those of the actual event provided while the user provided the instruction.

Additionally, the method may further comprise the steps of:
pursuant to the providing of all events of the initial list, generating a fourth list of events, the events of the fourth list having one or more parameter(s) identical to or similar to one or more parameters of the last provided event of the initial list and
providing events of the fourth list to the user.

Thus, the method may not stop providing events until instructed thereto by the user. Whenever all events of a list have been provided, and there is no “earlier” list to revert to, a new list may be generated and provided.

In a second aspect, the invention relates to a system for providing events to a user, the system comprising:
means for accessing events, each event being characterizable by one or more parameters,
means for providing, from the accessing means, an initial list of events,
means for providing events to the user,
controlling means adapted to control the event providing means and to receive an input from the user during the providing of an event,
means for providing, from the accessing means, another list of events, the events of the other list each having one or more parameter(s) identical to or similar to one or more parameters of a predetermined event,
   the controlling means further being adapted to:
initially determine a sequence/order of the events of the initial list and control the event providing means to provide, in the determined sequence/order, events from the first list,
upon receipt of an input from the user, determine which event is being provided and instruct the means for providing the other list to provide a second list of events each having one or more parameters identical/similar to parameters of the determined event,
then control the event providing means to provide events of the second list, and
finally, upon having provided all events of the second list or having received another input from the user, provide remaining events from the first list.

The present providing means may be the above player, stereo, TV, monitor or the like.

Naturally, the controlling means may be any type of controller, such as a PC, a microchip, a microcontroller, an ASIC, hardwired electronics, an FPGA, or the like, normally controlled by controlling instructions stored in a RAM, ROM, PROM, EPROM, EEPROM, Flash, tape, disc, card, electrical, magnetic, or optical, or the like. Any means for holding or storing events may be chosen from the same group. Any accessing means may comprise any networking elements, such as NIC's, network adapters, wireless communication devices, routers, switches, Bluetooth elements, IR communication elements, other computers or servers, thin clients, intra nets, the WWW, WANs, LANs or the like.

In one embodiment, the accessing means are adapted to identify available events stored in/on available storage means and/or the events available from one or more remote computers. Thus, both the WWW, net radio/video, airborne signals (radio/TV), purchase and download from the WWW and the like may be used.

As mentioned above, the means for providing the second list of events preferably comprise means for identifying events having the one or more identical/similar parameters in the abovementioned group.

Also, in one embodiment, the means for providing the second list of events comprise means for performing a real time analysis of the first event in order to determine the one or more parameter(s).

In addition, the controlling means preferably is also adapted to:
during the providing of events from the second list, receive a second input from the user,
determine which event is being provided and instruct the means for providing the other list to provide a third list of events each having one or more parameters identical/similar to parameters of the determined event,
then control the event providing means to provide events of the third list, and
finally, upon having provided all events of the third list or having received another input from the user, provide remaining events from the second list.

Finally, the controlling means may be adapted to, when all events of the initial list have been provided, determine the last provided event of the initial list and instruct the means for providing the other list to provide a fourth list of events each having one or more parameters identical/similar to parameters of the last provided event, and to then control the event providing means to provide the events of the fourth list.

In the following, preferred embodiments of the invention will be described with reference to the drawing in which:

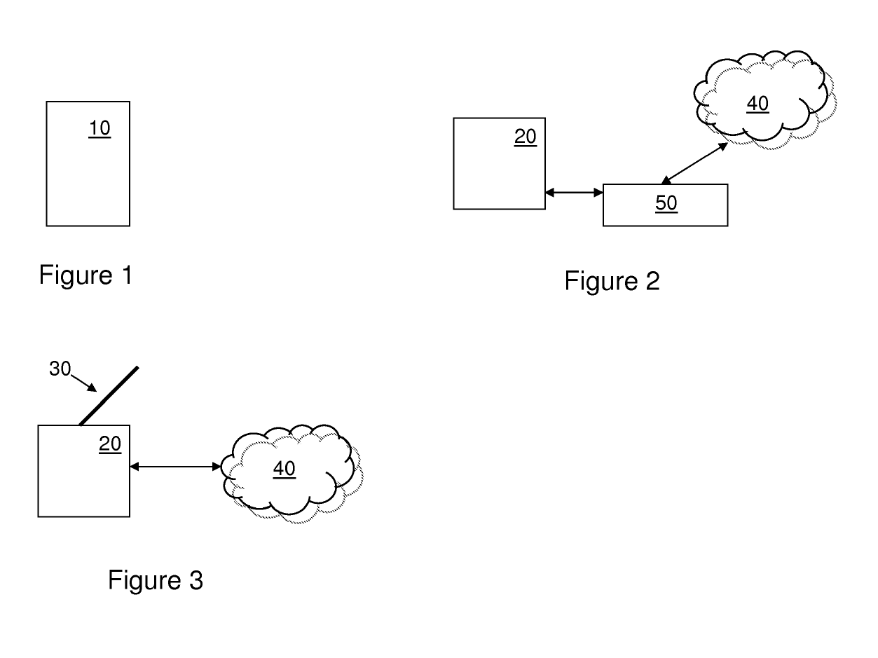

FIG. 1 illustrates an embodiment embodied within a stand-alone media player,

FIG. 2 illustrates an embodiment comprising a computer, a server and the WWW, and

FIG. 3 illustrates an embodiment comprising a computer and the WWW.

In general, the invention relates to the possibility of interrupting a play list with an instruction to generate a new play list with events relating to the event provided when providing the interruption.

Naturally, the events of the play list may be available in a number of manners. In FIG. 1, the embodiment is a stand-alone media player 10, such as an MP3-player, a cell phone, an e-book, a PCT, or a PDA-type apparatus. A number of play lists may be provided on a player of this type, such as by sorting the events available thereon using sorting criteria, such as artist, album, track or the like. In this stand-alone system, only events available, i.e. stored therein, may be used in the play lists.

In FIG. 2, a computer 20 is connected to a server 50, which again is connected to an external network 40, such as the WWW. The computer 20 may thus access events stored both internally, on the server 50 and on or via the network 40. Thus, the number of events available may be much larger when providing the play lists. Alternatively, FIG. 2 may illustrate a player as that illustrated in FIG. 1, which player now is connected to a computer and potentially also to the WWW in order to be able to access/download more events.

FIG. 3 illustrates a computer 20 connected to the WWW, which connection may be via any number of servers 50 or the like, and which also has an aerial 30 or other type of antenna for receiving events via a wireless connection, such as a standard radio/TV signal.

According to the present invention, it is not relevant where the events may be stored and how these are made available to the system having the means (such as a display/monitor and/or speakers/earphones) for providing the events to the user. Also, it is irrelevant how the events are stored, i.e. whether it is locally or remotely, whether it is in RAM/ROM/PROM/EPROM/EEPROM, flash, hard disc, tape, disc, card, electrical, magnetic, or optical storage, or the like.

Naturally, the controlling means controlling the providing of the events and potentially also generating the play lists may be any type of controller, such as a PC, a microchip, a microcontroller, an ASIC, hardwired electronics, an FPGA, or the like, normally controlled by controlling instructions stored in storing means as mentioned above.

The user interface may be any type of user interface. Normally, the user interface comprises both a display/monitor/sound emitter for providing information to the user as well as means for the user to input information or selections. These input means may be tactile, via buttons, a touch screen, a joystick, a rotatable wheel or the like, or be adapted to receive and interpret audio commands. Alternatively or in addition, the user may input information by moving the player in relation to him/herself or the surroundings, when movement detection means are provided.

Initially, the computer or player (10, 20) provides events, normally one at the time, to the user. The events to be provided are provided in a play list either stored or accessed by the computer/player 20/10. The full contents of the play list may or may not be predetermined and known by the computer/player 20/10. The events provided may be stored in or near the computer/player 20/10 or may be streamed from a more remote location.

During the providing of an event of the initial play list, the user may provide an instruction by using the user interface. Upon receiving this signal/instruction, the computer/player 20/10 will obtain one or more parameters characterizing the event.

Each event is categorized by one or more parameters. Parameters may be provided with the event from external sources, such as the adding of artist or composer by a distributor/producer, or may be derivable there from, such as by analysis of the event/group (beats-per-minute, genre, key, instruments, duration, etc.). In addition or alternatively, the user may him/herself provide parameters to the event. Any number of parameters may be obtained for each event.

In the present context, a parameter may be any piece of information describing the event or something connected thereto. Different standards exist for different types of events, such as the ID3.v2 standard for audio files and EXIF for video. Such parameters may be: author, artist, group, name, title, producer, date/year of production/issuance/birth, genre, theme, pace/beats-per-minute, key, played recently/never, most/never/recently used, oldies, or the like. In addition, a parameter may be a type of file in which the event is stored (tiff, mpeg, mp3, etc.).

Such parameters may also, for music or audio in general, such categories may be: author, artist (e.g. Justin Timberlake), group (e.g. the Jackson Five), composer (e.g. Andrew Lloyd Webber), label (e.g. EMI, mute record, motor music, . . . ), genre (e.g. pop, rock, beat, classic, jazz, . . . ), beats-per-minute, key, instruments used, name (of any person related to the music), title (such as of the track or album), producer (e.g. Quincy Jones), date/year of production/issuance/birth (of the track, album, artist, composer or any other person related to the music), theme (such as musical, film track), or any other characteristics of the audio. For movies, plays or other video, the categories may be the same, especially for music videos and musicals, but also other categories may be relevant, such as actor(s) (such as Tom Hanks), genre (family, action, thriller . . . ), director (such as George Lucas), or the like. For literature, books, articles or the like, other parameters may be relevant, such as publisher, and for even other events, particular parameters will be relevant for these.

Having received the instruction, the computer/player 20/10 or another element in the system, such as the server 50, will determine one or more events, such as a predetermined number of events, which have one or more parameters identical or similar to the parameter(s) of the provided event in order to provide a second list of events similar to the provided event.

In addition to the above instruction, the user may (or may have in advance) provide instructions as to which parameter(s) of the provided event is/are interesting in order to define or determine the similarity desired between the provided event and the events of the new play list.

Naturally, the desired similarity may differ within wide ranges, such as, for audio, a similarity may be desired in the key of the track, which instruments are used, the same artist, or the same singer in different combinations (Michael Jackson and the Jackson Five). Also, the year or decade of production may be relevant, as may the producers (Stock, Aitken and Waterman was a hot producer trio in the 80's). Thus, any parameter(s) may be used as may any combination thereof. Naturally, a variation of one or more parameters from the actual values of the provided event may be allowed.

One particular type of similarity may be a similarity as to spectral contents and rhythm. This is a difficult parameter to calculate, and may suggestions exist. One proposed manner is seen in WO 2006/050731 in which a spectrum analysis is performed and a rhythm analysis is used for deriving parameters of the track.

This analysis, as many other types of analysis, may be performed real-time during e.g. the providing of the track to the user.

As mentioned above, the similarity may be estimated on the basis of a number of parameters by, in a space of the same number of dimensions, estimating a distance (such as the Euclidian distance) between points defined by the parameter(s) of the individual events, or from angles between vectors in the same space determined by the parameters of the events.

As mentioned above, the user may select between different manners of determining similarity, i.e. different parameters or groups of parameters used for this determination. Different types of input or different input means may be provided for that purpose.

Having provided the new play list, the providing of the initial play list is interrupted, and the events of the new play list are provided.

Naturally, the user may again provide an instruction during the providing of an event from the new play list to again have the system provide yet another play list of events which are now similar to that played the last time the instruction was received.

The user may also enter an instruction instructing the system to terminate the actual play list, such as the new play list or the yet other play list and return to the former play list (the new play list or the initial play list). Alternatively, the system will revert to the former play list when all events of the actual play list have been provided.

When returning to a former play list, the event causing the user to enter the introduction of the instruction may be re-provided/played, or only remaining (i.e. not yet provided) events of the play list may be provided.

In addition, the system may automatically generate a new play list, when the last event of the initial play list has been provided in order to not merely stop providing events.

1. A method of providing events to a user, the method comprising:
providing an initial list of events, each event being characterizable by one or more parameters,
during providing of a first event from the initial list, receiving an input from the user,
generating a second list of events, the events of the second list having one or more parameter(s) identical to or similar to one or more parameters of the first event,
providing events of the second list to the user, and
subsequent to providing all events of the second list or to a second input from the user, providing remaining events of the initial list.

2. A method according to claim 1, wherein the steps of providing the lists of events comprises identifying available events stored in/on available storage means and/or the events available from one or more remote computers.

3. A method according claim 1, wherein the step of generating the second list comprises generating the second list from events having the one or more identical/similar parameters in the group of: author, artist, group, composer, label, genre, beats-per-minute, key, instrument(s) used, name, title, producer, date/year of production/issuance/birth, theme, actor(s), genre, director, and publisher.

4. A method according to claim 1, wherein the step of generating the second list comprises performing a real time analysis of the first event in order to determine the one or more parameters.

5. A method according to claim 1, further comprising the steps of:
during providing of a second event from the second list, receiving another input from the user,
generating a third list of events, the events of the third list having one or more parameter(s) identical to or similar to one or more parameters of the second event,
providing events of the third list to the user, and
subsequent to providing all events of the third list or to a second input from the user, providing remaining events of the second list subsequent.

6. A method according to claim 1, further comprising the steps of:
pursuant to the providing of all events of the initial list, generating a fourth list of events, the events of the fourth list having one or more parameter(s) identical to or similar to one or more parameters of the last provided event of the initial list and
providing events of the fourth list to the user.

7. A system for providing events to a user, the system comprising:
means for accessing events, each event being characterizable by one or more parameters,
means for providing, from the accessing means, an initial list of events,
means for providing events to the user,
controlling means adapted to control the event providing means and to receive an input from the user during the providing of an event,
means for providing, from the accessing means, another list of events, the events of the other list each having one or more parameter(s) identical to or similar to one or more parameters of a predetermined event,
the controlling means further being adapted to:
initially determine a sequence/order of the events of the initial list and control the event providing means to provide, in the determined sequence/order, events from the first list,
upon receipt of an input from the user, determine which event is being provided and instruct the means for providing the other list to provide a second list of events each having one or more parameters identical/similar to parameters of the determined event,
then control the event providing means to provide events of the second list, and
finally, upon having provided all events of the second list or having received another input from the user, provide remaining events from the first list.

8. A system according to claim 7, wherein the accessing means are adapted to identify available events stored in/on available storage means and/or the events available from one or more remote computers.

9. A system according claim 7, wherein the means for providing the second list of events comprise means for identifying events having the one or more identical/similar parameters in the group of: author, artist, group, composer, label, genre, beats-per-minute, key, instrument(s) used, name, title, producer, date/year of production/issuance/birth, theme, actor(s), genre, director, and publisher.

10. A system according to claim 7, wherein the means for providing the second list of events comprise means for performing a real time analysis of the first event in order to determine the one or more parameter(s).

11. A system according to claim 7, wherein the controlling means is additionally adapted to:
during the providing of events from the second list, receive a second input from the user,
determine which event is being provided and instruct the means for providing the other list to provide a third list of events each having one or more parameters identical/similar to parameters of the determined event,
then control the event providing means to provide events of the third list, and
finally, upon having provided all events of the third list or having received another input from the user, provide remaining events from the second list.

12. A system according to claim 7, wherein the controlling means is adapted to, when all events of the initial list have been provided, determine the last provided event of the initial list and instruct the means for providing the other list to provide a fourth list of events each having one or more parameters identical/similar to parameters of the last provided event, and to then control the event providing means to provide the events of the fourth list.
